(19) United States
(12) Patent Application Publication
(10) Pub. No.: US 2010/0268861 A1
(43) Pub. Date: Oct. 21, 2010

(54) USB DRIVE

(75) Inventors: ZHANG-SHUN SHI, Shanghai (CN); KAI DONG, Shanghai (CN)

Correspondence Address: Altis Law Group, Inc.;ATTN: Steven Reiss, 288 SOUTH MAYO AVENUE, CITY OF INDUSTRY, CA, 91789, US

(73) Assignees: AMBIT MICROSYSTEMS (SHANGHAI) LTD., SHANGHAI (CN); HON HAI PRECISION INDUSTRY CO., LTD., Tu-Cheng (TW)

(21) Appl. No.: 12/482,465

(22) Filed: Jun. 11, 2009

(30) Foreign Application Priority Data
Apr. 16, 2009 (CN) 200920302261.3

(51) Int. Cl. G06F 13/20; G06F 12/02

(52) U.S. Cl. 710/313; 711/103; 711/E12.008

(57) ABSTRACT

A universal serial bus (USB) drive includes a control button, a control signal generating circuit, a flash memory, a connection port, a processor, and an indication lamp. The USB drive generates a removal instruction from a connection device, according to a user operation thereon. The USB drive determines whether the flash memory is in a working state and controls the connection port to disconnect from the connection device, if the flash memory is not in the working state. The indication lamp on the USB drive provides a notification that the connection port is disconnected from the connection device.

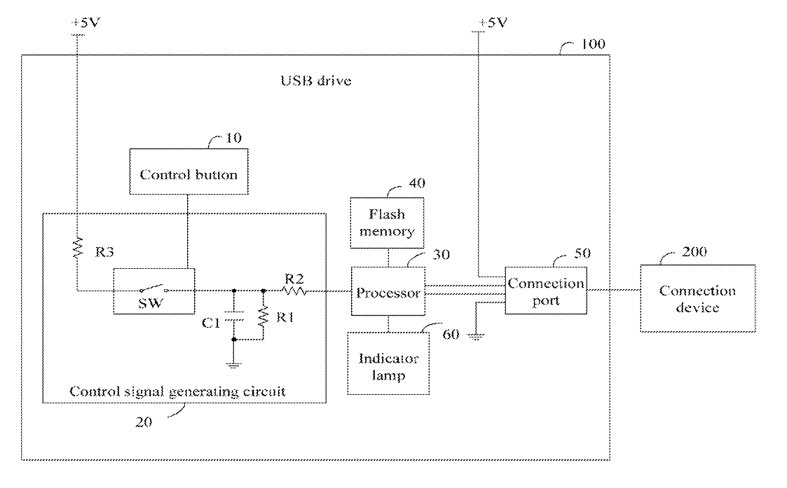

### BACKGROUND

1. Technical Field

Embodiments of the present disclosure relate to a universal serial bus (USB) drive.

2. Description of Related Art

Universal serial bus (USB) drives allow convenient connection of devices. Most electronic devices, especially peripheral communication devices, such as mobile phones, personal digital assistants (PDAs), and others utilize USB connections.

Even so, manual removal of a USB device requires access to an operating system (OS) through a display. Given the increasing use and connection of USB devices, the method is time-consuming and inconvenient.

### BRIEF DESCRIPTION OF THE DRAWINGS

The FIGURE depicts a block diagram of an embodiment of a universal serial bus (USB) drive according to the present disclosure.

### DETAILED DESCRIPTION

Referring to the figure, a block diagram of an embodiment of a universal serial bus (USB) drive 100 is shown, in communication with a connection device 200. The USB drive 100 comprises a control button 10, a control signal generating circuit 20, a processor 30, a flash memory 40, a connection port 50, and an indication lamp 60.

The control button 10 is operable to generate a removal instruction from the connection device 200, according to a user operation thereon. In one embodiment, the control button 10 generates the removal instruction when activated. In one embodiment, the control button 10 is arranged on the USB drive 100.

The control signal generating circuit 20, the processor 30, the flash memory 40, the connection port 50, and the indication lamp 60 are powered by the connection device 200 through connection port 50. In one embodiment, a reference voltage supplied through the connection port 50 is +5V, for example.

The control signal generating circuit 20 is electrically connected to the control button 10, and operable to generate a removal control signal in response to removal instruction from the control button 10.

The control signal generating circuit 20 comprises a control switch SW, a capacitor C1, a first voltage dividing resistor R1, a current-limiting resistor R2, and a second voltage dividing resistor R3.

The control switch SW is connected to the control button 10. The control switch SW switches off when the control button 10 generates no removal instruction, and switches on when the control button 10 generates the removal instruction.

The capacitor C1 is connected between a first end of the control switch SW and a ground, to filter noise produced by the control switch SW. The current-limiting resistor R2 is connected between the first end of the control switch SW and the processor 30. The first voltage dividing resistor R1 is connected between the first end of the control switch SW and the ground. The second voltage dividing resistor R3 is connected between a second end of the control switch SW and the reference voltage. The first voltage dividing resistor R1 and the second voltage dividing resistor R3 are operable to divide the reference voltage to generate the removal control signal when the control switch SW switches off. In one embodiment, the removal control signal is a high level voltage, such as +3.3 V, for example.

The flash memory 40 is operable to store data. A working state of the flash memory 40 means the flash memory 40 is exchanging data with the connection device 200 via the processor 30 and the connection port 50.

The connection port 50 provides a connection to connection device 200. The connection port 50 comprises two control wires and two voltage wires. The two control wires are connected to the processor 30, operable to receive differential signals from the processor 30. The two voltage wires are connected to the reference voltage and the ground, respectively.

The processor 30 is connected to the flash memory 40, and the connection port 50. The processor 30 is operable to determine whether the flash memory 40 is in the working state, when receiving the removal control signal from the control signal generating circuit 20. The processor 30 is further operable to direct the connection port 50 to continue connecting to the connection device 200, if the flash memory 40 is in the working state. Otherwise, the processor 30 is further operable to disconnect from the connection device 200 if the flash memory 40 is not in the working state.

The processor 30 is connected to the connection port 50 via the two control wires, operable to control the connection between the connection port 50 and the connection device 200. In one embodiment, the processor 30 transmits two equal differential signals to the connection port 50 respectively via the two control wires, so as to direct the connection port 50 to disconnect from the connection device 200. In another embodiment, the processor 30 may transmit two unequal differential signals to the connection port 50 respectively via the two control wires, to direct the connection port 50 to continue connecting to the connection device 200.

The indication lamp 60 is under control of the processor 30, to indicate a connection state of the connection port 50. When the connection port 50 is disconnected from the connection device 200, the indication lamp 60 indicates that the device can be removed safely by changing color or brightness. Conversely, when the connection port 50 is still connected, the indication lamp 60 provides a different indication that the device cannot be removed safely.

According to the disclosure, the USB drive 100 can be quickly removed by activation of the control button 10, providing enhanced convenience.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A universal serial bus (USB) drive, comprising:
a control button operable to generate a removal instruction from a connection device, according to a user operation thereon;
a control signal generating circuit electrically connected to the control button, operable to generate a removal control signal in response to the removal instruction from the control button;
a flash memory operable to store data;
a connection port adapted to connect to the connection device;
a processor to determine whether the flash memory is in a working state when receiving the removal control signal from the control signal generating circuit, and direct the connection port to disconnect from the connection device if the flash memory is not in the working state; and
an indication lamp under control of the processor, operable to provide a notification that the connection port be disconnected from the connection device.

2. The USB drive as claimed in claim 1, wherein the control signal generating circuit comprises:
a control switch connected to the control button, operable to switch off when not receiving the removal instruction from the control button, and switch on when receiving the removal instruction from the control button;
a capacitor connected between a first end of the control switch and a ground, operable to filter noise generated by the control switch;
a first voltage dividing resistor connected between the first end of the control switch and the ground;
a second voltage dividing resistor connected between a second end of the control switch and a reference voltage, wherein the first voltage dividing resistor and the second voltage dividing resistor are operable to divide the reference voltage to generate the removal control signal when the control switch switches on; and
a current-limiting resistor connected between the first end of the control switch and the processor.

3. The USB drive as claimed in claim 2, wherein the processor is connected to the connection port via two control wires.

4. The USB drive as claimed in claim 3, wherein the processor is further operable to transmit two equal differential signals to the connection port respectively via the two control wires, to direct the connection port to disconnect from the connection device.

5. The USB drive as claimed in claim 4, wherein the processor is further operable to transmit two unequal differential signals to the connection port respectively via the two control wires, to direct the connection port to continue connecting to the connection device.

6. The USB drive as claimed in claim 1, wherein the removal control signal is a high level voltage signal.

7. The USB drive as claimed in claim 1, wherein the control button generates the removal instruction when activated.
